(19) United States
(12) Patent Application Publication
(10) Pub. No.: US 2011/0202465 A1
(43) Pub. Date: Aug. 18, 2011

(54) SYSTEM AND METHOD FOR FACILITATING POINT OF SALE TRANSACTIONS WITH MINIMAL TRANSFER OF SENSITIVE DATA

(76) Inventor: Ashraf Mashhour, (US)

(21) Appl. No.: 13/094,766

(22) Filed: Apr. 26, 2011

Related U.S. Application Data
(63) Continuation-in-part of application No. 10/546,543, filed on Oct. 31, 2005, now abandoned.

(30) Foreign Application Priority Data
Nov. 24, 2002 (EG) 2002111268

(51) Int. Cl. G06Q 20/00; G06Q 30/00; H04L 9/32; H04L 9/30

(52) U.S. Cl. 705/67; 705/71

(57) ABSTRACT

Disclosed herein are a system and method for facilitating point of sale transactions with minimal transfer of sensitive data corresponding to a consumer or merchant. The system and method comprise connecting to a central banking system using a communications apparatus for connecting to a landline or mobile communications network. The communications apparatus is coupled to one or more slots for receiving a merchant digital token and a consumer digital token storing merchant public and private keys and consumer public and private keys, respectively. The merchant and consumer public keys are used to identify the merchant and consumer, respectively, to the central banking system. The merchant and consumer private keys are used to sign, and thereby authenticate, a merchant sign-on agreement and a payment authorization form, respectively.

### RELATED APPLICATIONS

This patent application is a continuation-in-part of Egyptian Patent Application No. 2002111268, filed in the Arab Republic of Egypt on Nov. 24, 2002, and claims benefit and priority thereto under 35 U.S.C. §119. International Patent Application No. PCT/EG 03/00007 entitled “Scheme for Spreading and Facilitating Remote E-Services”, with international filing date Nov. 13, 2003, claims priority to Egyptian Patent Application No. 2002111268 and is incorporated herein by reference. International Patent Application No. PCT/EG 03/00007 entered the national stage in the United States under 35 U.S.C. §371(c) as U.S. patent application Ser. No. 10/546,543 on Oct. 31, 2005.

### FIELD OF THE INVENTION

The invention is related to the fields of Data Communications via means of mobile and fixed line telephones using the Electronic Service applications of Internet, WAP (Wireless Application Protocol) and IVR (Interactive Voice Response).

The invention is an innovative solution that introduces one orchestrated scheme of remote accessing of electronic services (e-Commerce, e-Government) and e-Payment that enjoy a good level of authentication of the remote user identity and as well enjoy a good level of personalized access control of remote users and a good level of protection of their processed transactions.

The presented invention provides means of accessing electronic services remotely (while at home or office) in a secured manner that complements the onsite secured accessing of electronic services (while at banks, commercial malls, shops . . . etc) using the POS (Point Of Sale) and ATM (Automatic Teller Machines).

### BACKGROUND

In the background art, the e-Services/e-Payment applications that enjoy a good level of end-user authentication/authorization functionalities are either
Mobile Devices based applications, or
Desktop Personal Computer/Internet based applications, or
Fixed-Phones/Chip Card Reader applications.

In background art, the following points are noted in the Mobile Devices based applications:
The e-Services (e-Government and e-Commerce) and e-Payment solutions are available for Mobile Devices' users and can be processed via SMS, Internet and WAP (Wireless Application Protocol) applications.
   Some of these Mobile based “e-Services/e-Payment” solutions enjoy a good level of authentication/authorization techniques, where these solutions:
      Depend on using the SIM Cards in association with the SIM based applications that are installed within the central management systems of the Telecom Operator managing mobile phone networks.
      Utilize the inside plant systems of the Mobile Telecom Operators, that are normally used to manage the mobile phone services, after introducing to it the necessary development and re-engineering activities to make it suitable for managing and controlling the “e-Services and e-Payment” transactions.
      Include authentication/authorization processes of end-users requesting to access “e-Services/e-Payment” applications and handle their transactions, where these authentication/Authorization processes utilize various security and protection techniques/tools, such as:
         Public Key and Private Key Infrastructure (PKI).
         Electronic Signature.
         Data Encryption/Decryption.
         . . . Etc).
   End-user has to have a Handheld Device or a Laptop (or Pocket) Personal Computer equipped with wireless communication facilities (such as GSM or GPRS).
   Effecting e-Payments via most of these applications necessitate that end-user has a Credit Card
   Some of the Mobile based applications permit the use of the prepaid cards.
   Some of the Mobile based applications accommodate for the prepaid (interim) account techniques, that reduce payment risks and cater for the legal requirements that may be entailed by some financial institutions.
   The handling of the e-Services/e-Payment transactions via SMS, WAP or Internet (using Laptop or Pocket PC's) applications require end-user to have technical competence/PC literacy.
   The handling of the e-Services/e-Payment transactions Via IVR
   (Interactive Voice Response) is not as convenient as using the IVR via fixed-line telephone sets.

In background art, the following points are noted in the Desktop Personal Computer/Internet based applications:
It is possible to authenticate the end-user identity using Smart Cards applications, in which case the PC has to be equipped with a USB port (Universal Serial Bus) or with an RS232 interface (parallel or serial ports) to connect the Smart Card reader to the Desktop PC.
In case of using Smart Cards/Smart Cards Readers, the end-user has to install special software programs that are necessary to complement the e-Services/e-Payment central systems in handling of the authentication/authorization processes, where installing such a special software on the end-user PC side has the following limitations:
   The first limitation is the complexity added to the end-user responsibilities to be able to handle e-Services and e-Payments.
   The second limitation is the security weaknesses that associate the installation of authentication/authorization software on the remote end PC, outside the control of centralized systems governing the e-Services/e-Payments transactions.
Some of the Desktop PC applications realize the security of the e-Payments via Credit Cards through the use of “Authorization Codes” (without using Smart Cards as a physical authentication token), where the end-user (Consumer) effects e-Payments via Credit Cards in association with the use of “Authorization Codes” that are stored on an Agent's host (interim/prepaid account) in addition to the data of the Vendors accepting such “Authorization Codes”. The limitations of such a solution are mainly represented in the complexity of the setup and the low appreciation of the introduced security perceived by the Credit Card holder consumers.
In the solutions that are based on the Internet/PC applications, the end-user has to have a desktop personal computer equipped with a Fax/Modem device or card, the thing that hinders the spreading of the electronic services usage, specially within developing country environments, due to the following reasons:
   Limited number of installed PCs within a greater number of households, and relatively smaller number of households can afford purchase of a PC.
   The lack of skills needed to use the PCs and internet applications within a majority of individuals specially within developing countries limits the number of individuals who are capable of using the Internet applications compared to the number of individuals who can conveniently use the fixed-line IVR services.
Effecting e-Payments necessitate that end-user has a Credit Card, this again hinders the spreading of the electronic services usage, specially in the developing countries where the incomes are low and people who can afford to have bank accounts or credit cards are limited.

In background art, the following points are noted in the Fixed-Phones/Chip Card Reader applications:
There is an introduced solution that adds a “Chip Card Reader” to the Landline Handset to transform it to a POS-Alike apparatus.
The end-user, requesting to remotely access his/her bank account, will be authenticated upon dialing the “Tele-Banking” central exchange systems, where system will prompt the end-user to insert his/her “Chip Card” into the “Chip Card Reader”.
In the authentication process, the “Chip Card Reader” takes over the landline and forwards the authentication data stored on the “Chip Card” to an authentication mechanism installed at the central exchange of the dialed system and upon completion of the authentication process the “Chip Card Reader” surrenders the landline and the end-user becomes able to remotely perform requested transactions.
To effect remote e-Payments, the “Chip Card” is used as an electronic purse, where the end-user re-fills an amount of money from his/her bank account into the electronic purse through dialing the “Tel-Banking System”, and can afterwards dial the “Service Provider System” to upload the amount of money from the electronic purse, where in the later case, both of the authentication and money transfer processes are performed when the “Chip Card Reader” takes over the landline.
The previously available “Chip Card Reader” solution is primitive, and is inconvenient to end-users, as it requires multiple dialing and authentication processes to be done to perform a simple operation of remote transfer of a monetary amount from the end-user bank account to the service provider account.
The previously available “Chip Card Reader” solution, does not cope with the authentication/authorization processes required when the end-user requires to access the e-Services/e-Payment through internet websites using a Desktop Personal Computer hooked to the landline.
The previously available “Chip Card Reader” does not read the SIM cards used in Mobile Phones/Devices and consequently does not enable the providers nor the end-users of benefiting from the e-Services/e-Payment systems and solutions that are currently available for the Mobile Platform.

In addition, and considering the various solutions that are available in the background art (Mobile Devices, Desktop PC/Internet and/or Fixed Phone/Chip Card Reader), none of these inventions had introduced one unified solution that embodies in one orchestrated scheme and caters for the following items:
Interchangeable and integrated use of all various types of SIM and Smart Cards that are used in Mobile Phones, ATM/POS machines, Card Readers connected to Personal Computers and Card Readers connected to (or integrated inside) landline handsets.
Integrated and complementary use of the various types of e-Payment embodiments (prepaid cards, prepaid accounts, credit cards, debit cards, . . . etc).
Applicability and compatibility with all various e-Services Access tools, apparatus and terminals (Mobile Phones, Handheld Devices, Personal Computers connected to landlines as well as Fixed-Line Telephone Handsets without the need to use any Personal Computers).
Availability of various types of e-Services/e-Payment applications (IVR, Internet and WAP) through one unified and orchestrated e-Services/e-Payment Scheme.

### BRIEF DESCRIPTION OF DRAWINGS

FIG. 1: Demonstrates the connections of the fixed line telephone set and the external SIM/Smart card reader device.

Item (1) Fixed line telephone outlet.

Item (2) The external SIM/Smart card reader device.

Item (3) Parallel telephone line port, for connecting desktop personal computers (data port).

Item (4) Telephone line input port.

Item (5) The new e-Services normal size Smart card.

Item (6) The new e-Services SIM card.

Item (7) 2.5″ Paper-roll Thermal (or Ink) Printer.

FIG. 2: Demonstrates the connections of a desktop personal computer, fixed line telephone set and external SIM/Smart card reader device.

Item (1) Fixed line telephone outlet.

Item (2) The external SIM/Smart card reader device.

Item (3) Parallel telephone line port, for connecting desktop personal computers (data port), connected to a desktop Personal Computer.

Item (4) Telephone line input port.

Item (5) The new e-Services normal size Smart card.

Item (6) The new e-Services SIM card.

Item (7) 2.5″ Paper-roll Thermal (or Ink) Printer.

Item (8) Enlarged picture of the new e-Services normal size Smart card.

Item (9) Enlarged picture of the new e-Services SIM card.

FIG. 3: Demonstrates a desktop personal computer connected to a fixed line network via fax/modem card and the external card reader device.

Item (1) Fixed line telephone outlet.

Item (2) The external SIM/Smart card reader device.

Item (3) Fixed telephone line connected directly to a desktop Personal Computer via fax/modem card.

Item (4) Fixed telephone line connected to the ground network.

Item (5) The new e-Services normal size Smart card.

Item (6) The new e-Services SIM card.

Item (7) 2.5″ Paper-roll Thermal (or Ink) Printer.

Item (8) Enlarged picture of the new e-Services normal size Smart card.

Item (9) Enlarged picture of the new e-Services SIM card.

FIG. 4: Demonstrates the connection of a fixed line telephone set with internally integrated SIM/Smart card reader device.

Item (1) Fixed line telephone outlet.

Item (2) A new fixed line telephone set with a SIM/Smart card reader integrated inside.

Item (3) Parallel telephone line port, for connecting desktop personal computers (data port).

Item (4) Telephone line input port.

Item (5) The new e-Services SIM/Smart card.

Item (6) Input/Output port for connecting the 2.5″ Paper-roll Thermal (or Ink) Printer.

Item (7) 2.5″ Paper-roll Thermal (or Ink) Printer.

Item (8) Enlarged picture of the new e-Services SIM card.

Item (9) Enlarged picture of the new e-Services normal size Smart card

FIG. 5: Demonstrates a desktop Personal Computer connected to a fixed line telephone set with the new SIM/Smart card reader integrated inside.

Item (1) Fixed line telephone outlet.

Item (2) A new fixed line telephone set with a SIM/Smart card reader integrated inside.

Item (3) Parallel telephone line port, for connecting desktop personal computers (data port), connected to a desktop Personal Computer.

Item (4) Telephone line input port.

Item (5) The new e-Services SIM/Smart card.

Item (6) Input/Output port for connecting the 2.5″ Paper-roll Thermal (or Ink) Printer.

Item (7) 2.5″ Paper-roll Thermal (or Ink) Printer.

Item (8) Enlarged picture of the new e-Services SIM card.

Item (9) Enlarged picture of the new e-Services normal size Smart card

FIG. 6: Demonstrates the access of e-Services via cellular network using various mobile devices (portable Personal Computer connected to a mobile phone, handheld communicator device, PDA . . . etc).

Item (1) Mobile phone device.

Item (2) Special cable to connect mobile phones to portable Personal Computers.

Item (3) Portable personal computer.

Item (4) PDA (Personal Digital Assistant) device.

Item (5) Handheld communicator device.

FIG. 7: Demonstrates a general schematic diagram of the various access alternatives to the central e-Services provider.

Item (1) The equipment and infrastructure systems and applications installed within the inside plant of the Telecom Operator assigned the responsibility of the e-Services access provision.

Item (2) The equipment and infrastructure systems and applications installed within the inside plant of the fixed line network telephone operator.

Item (3) Equipment and infrastructure systems and applications of a mobile operator rather than the one providing the e-Services.

Item (4) Mobile phone communicates with the e-Services Telecom Operator, through another mobile operator.

Item (5) Portable Personal Computer communicates via a mobile phone with the e-Services Telecom Operator through another mobile operator.

Item (6) Fixed line telephone set with the new SIM/Smart card reader integrated inside and communicates with the e-Services Telecom Operator through a Fixed-Line Network Telecom Operator.

Item (7) Desktop personal computer connected to the ground line network and equipped with the new SIM/Smart card reader.

Item (8) Portable Personal Computer communicates directly with the eServices Telecom Operator via a mobile phone.

Item (9) The newly suggested e-Services mobile phone that supports only e-Services and remote payments, communicates with the Telecom Operator providing the e-Services.

FIG. 8: Demonstrates a schematic diagram for the internal components of the new SIM/Smart card reader device (internal or external).

Item (1) Power supply circuits with matching impedance equivalent to the fixed telephone line impedance, the power supply circuits generate from the voltage of the fixed line the voltages needed to operate the SIM/Smart card reader circuits and components.

Item (2) Logic and control circuits.

Item (3) Voltage bus.

Item (4) The new SIM card.

Item (5) SIM reader cartridge.

Item (6) Controlled bus circuitry with a matching impedance equivalent to the fixed line impedance.

Item (7) Three-way gating control circuit with a matching impedance equivalent to the telephone line impedance.

Item (8) MODEM, communication and logic circuits to code/decode the logical addresses, instructions and tones with appropriate matching impedance equivalent to the fixed line circuitry.

Item (9) The fixed telephone line connected to the ground network, and connected in parallel to the new SIM/Smart card reader.

Item (10) TCP/IP Processor to enable the end-user to directly communicate with Internet websites that provide the e-Services and handle the e-Services IVR and Internet applications.

Item (11) Flash ROM/RAM.

Item (12) 2.5° Paper-roll Thermal (and Ink) printer logic circuits and adapter (similarly logic circuits and adapter exist to operate and handle the Small LCD Display Screen).

Item (13) Input/Output port to connect the 2.5° Paper-roll Thermal (or Ink) printer (similarly an Input/Output port exist connect the Small LCD Display Screen).

Item (14) Enlarged picture of the new e-Services normal size Smart card.

Item (15) Enlarged picture of the new e-Services SIM card.

Item (16) Normal size Smart card entry slot.

FIG. 9: Demonstrates a 3D schematic of the new SIM/Smart card reader device (external model).

Item (1) External casing of the SIM/Smart card reader device (external model), and the figure item demonstrates the small size of the external device (around 8×10×2.5 cm).

Item (2) Ground telephone line input port (RJ type connector).

Item (3) Ground telephone line output port (RJ type connector).

Item (4) Input/Output port to connect the 2.5° Paper-roll Thermal (or Ink) printer.

Item (5) Output port to connect the Small LCD Display Screen.

Item (6) Picture of the new e-Services SIM card.

Item (7) Picture of the new e-Services normal size Smart card.

Item (8) USB port to connect SIM/Smart card reader device to Personal Computers via USB cable.

FIG. 10: illustrates a point-of-sale device according to an embodiment of the invention.

Item (1) SIM card slot for communication with central banking system

Item (2) RJ connection for communication with central banking system

Item (3) RJ connection for communication with central banking system

Item (4) Magnetic stripe card slots for consumer and merchant

Item (5) SIM card slot for consumer

Item (6) SIM card slot for merchant

Item (7) Paper roll

Item (8) LCD screen

Item (9) Keypad

FIG. 11: illustrates a consumer or merchant public key according to an embodiment of the invention.

FIG. 12: illustrates a point-of-sale device according to an embodiment of the invention.

Item (1) SIM card slot for communication with central banking system

Item (4) Magnetic stripe card slot for the consumer or merchant

Item (5) SIM card slot for the consumer or merchant

### DETAILED DESCRIPTION OF THE INVENTION

The objective of this invention is to achieve the following:
Extend the use of the e-Services/e-Payment tools and applications, that utilize SIM Cards in authenticating remote end-users, and that currently exist on the Mobile Phones platform to the Fixed-Phones platform (for the objective of the presented invention the central systems that will be re-engineered/developed to manage and control the e-Services/e-Payment applications, can be the inside plant central systems of a Mobile Phones Telecom Operator, or also can be the inside plant Intelligent Network Systems of a Fixed Phones Telecom Operator that are normally used to manage the fixed phone subscribers' services).
Introduce a scheme that helps in closing the “Digital Divide” by enabling the poor and lowly educated personnel round the whole world (and specially within the developing countries) of easily and confidently using the e-Services and effecting e-Payments remotely, where:
   The end-users will be able to interact with the e-Services transactions via IVR (Interactive Voice Response) applications without the need for any Personal Computers, while enjoying the values of authentication/authorization controls, through the use of a handy card reader tool that is easily connectable to fixed line telephone sets via normal RJ type connectivity.
   The introduced scheme will enable the end-users of effecting e-Payments via prepaid cards/electronic banking scheme without the need of having credit.
   Introduce a scheme that also provides values to the end-users who are rich, professional and highly educated, where it introduces new service features that can be added to the use of credit cards (such as Visa, Masters, . . . etc) that would eliminate the possibility of unjustified use of credit cards in effecting e-Payments over the internet.
   Introduce a scheme that avails for all types of users (whether they are poor or rich, highly or lowly educated, using IVR or Internet) one unified authentication/authorization scheme that links and integrates the following various e-Services and e-Payment tools and technology solutions and avail it through One Orchestrated Scheme:
   Various types of SIM and Smart Cards that are used in Mobile Phones, ATM/POS machines, Card Readers connected to Personal Computers and card readers connected to (or integrated inside) landline handsets.
   Various types of e-Payment mechanisms (prepaid cards, prepaid accounts, credit cards, debit cards, . . . etc).
   Various e-Services Access tools, apparatus and terminals (Mobile Phones, Handheld Devices, Personal Computers connected to Fixed-Line Phones as well as Fixed-Line Phones without the need to use any Personal Computers).
   Various types of e-Services/e-Payment applications (IVR, Internet and WAP).
Provide the e-Services/e-Payment end-users with Printed Payment Receipts through various alternatives (end-user local printing facilities, ATM machines printing services and/or e-Services Provider Printing Facilities and delivering printed receipts to end-user via mailing courier).

To achieve the above mentioned objectives, the presented invention introduces the following:
Two versions of Smart Cards to be issued for each e-Services Subscriber, where:
   Version #1, a new e-Services SIM Card (which is a modified smart version of the SIM cards currently used in mobile phones), where the e-Services end-user can use this new SIM card to perform the following:
      The traditional mobile phone services
      Acquire e-Services from e-Service Providers and perform the respective e-Service and e-Payment transactions through the e-Services applications and authentication/authorization processes, similar to what is currently available for Mobile Phones/Wireless Devices.
      In addition the end-user can use the very same SIM Card in association with the Fixed-Line Phones through the use of the new SIM/Smart Cards Reader described in the claim item #3 mentioned below in this report, where the end-user will be able to acquire e-Services from e-Service Providers and perform the respective e-Service transactions through the e-Services IVR applications (without the need for Personal Computers), or through the Internet applications (using Personal Computers), in association with the authentication/authorization processes in place.
   Version #2, is a new e-Services Smart Card (a modified smart version of the cards normally used in Automatic Teller Machines “ATMs”), where the e-Services end-user can use this new Smart Card to perform the following:
      The traditional Automatic Teller Machines “ATMs” services.
      In addition the end-user will be able to use the same Smart Card in association with the novel SIM/Smart Cards Reader that is also introduced through this invention (and described in the claim item #3 mentioned below in this report), where the end-user will be able to acquire e-Services from e-Service Providers and perform the respective e-Service and e-Payment transactions via Fixed-Line Phones, while enjoying the values of the authentication/authorization processes in place via the very same e-Services applications and authentication/authorization processes currently available for Mobile Phones/Wireless Devices. Where, the e-Service/e-Payment applications will be available through:
         IVR applications (without the need for Personal Computers), or
         Internet applications (using Personal Computers connected to Fixed-Line Phones).
   The two versions of the e-Services Cards (SIM and Smart Cards) will be issued by the entity/organization responsible on a country level for providing the Public Key/Private Key Infrastructure needed for the e-Services/e-Payments. This organization shall allow and coordinate with:
   The normal mobile operators to add the cellular telephone line data on the same e-services SIM Card, so that the end-user can use the same new SIM Card for e-services in addition to the cellular telephone line voice calls, and other mobile phone services provided by the mobile operator.
   Banks and Financial Services Institutions (such as Visa, Master Card, American Express . . . etc) to add their end-user data on the same e-Services SIM and normal size Smart Cards, so that the end-user can use the same new SIM or normal size Smart Cards for the e-Services provided through the invented scheme in addition to the normal banking, financial and e-Payment services that are (and will be) provided by these banks and financial institutions, where the end-user will be enjoying the same level of authentication/protection privileges provided by the invented scheme for the landline users accessing the e-Services via IVR or Internet applications.

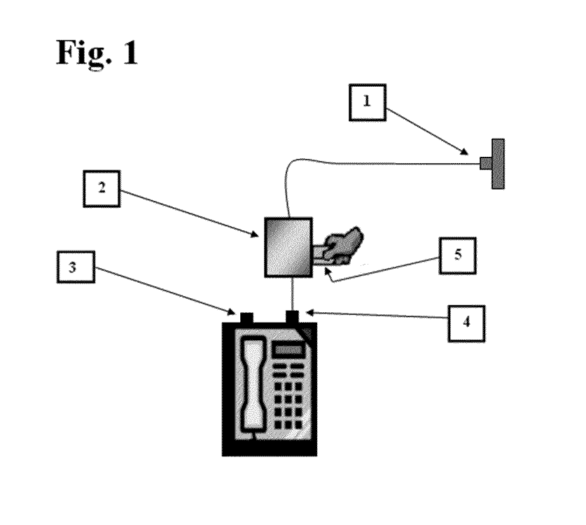

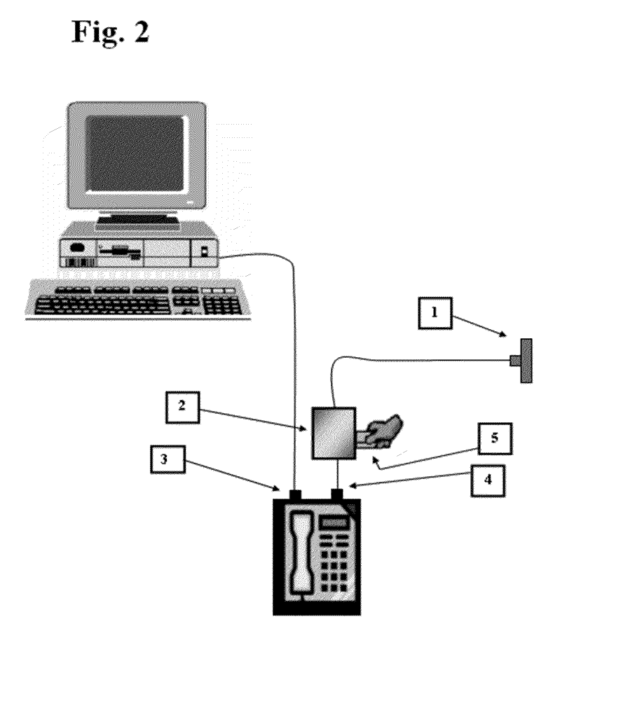

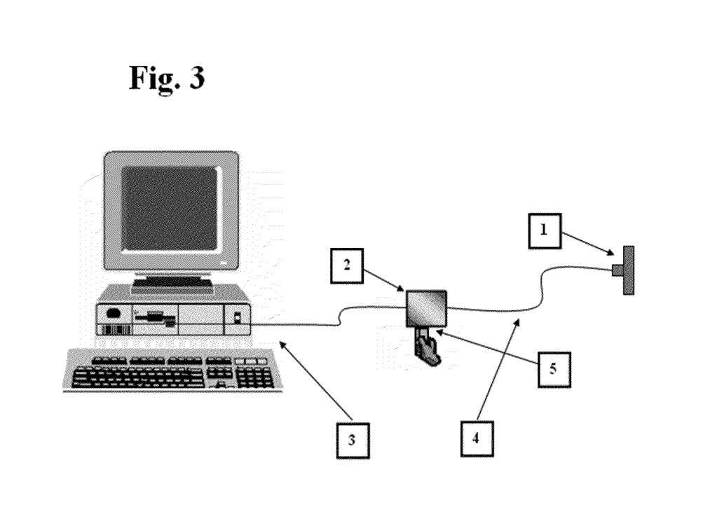

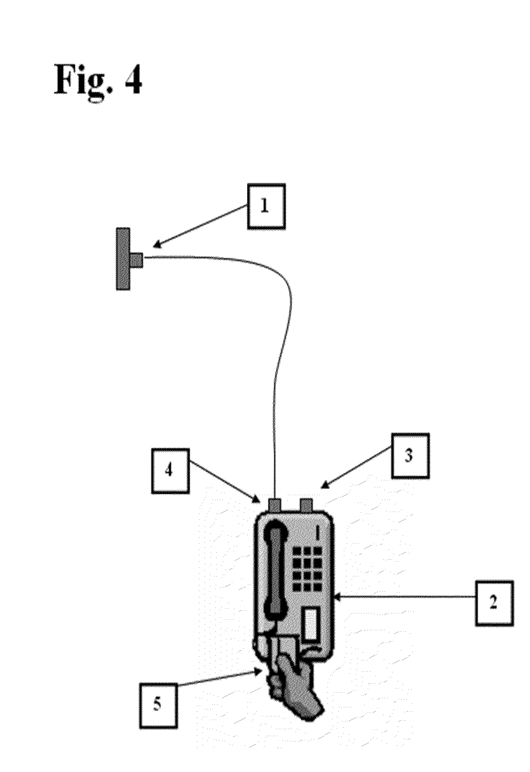

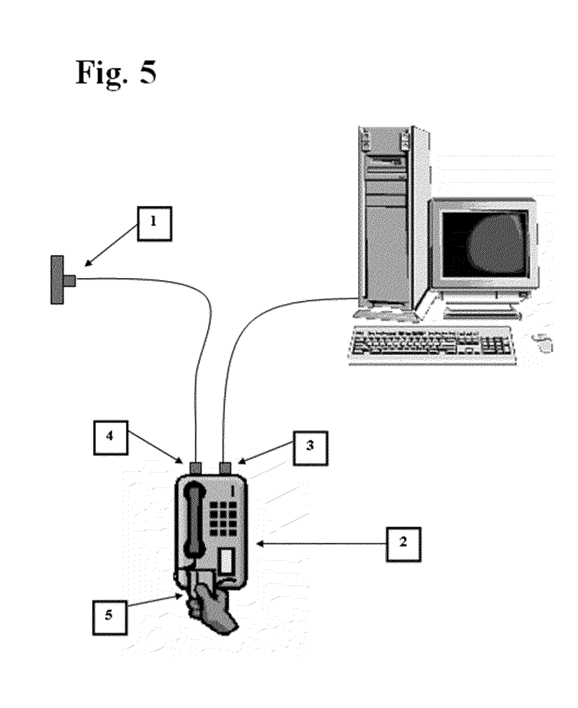

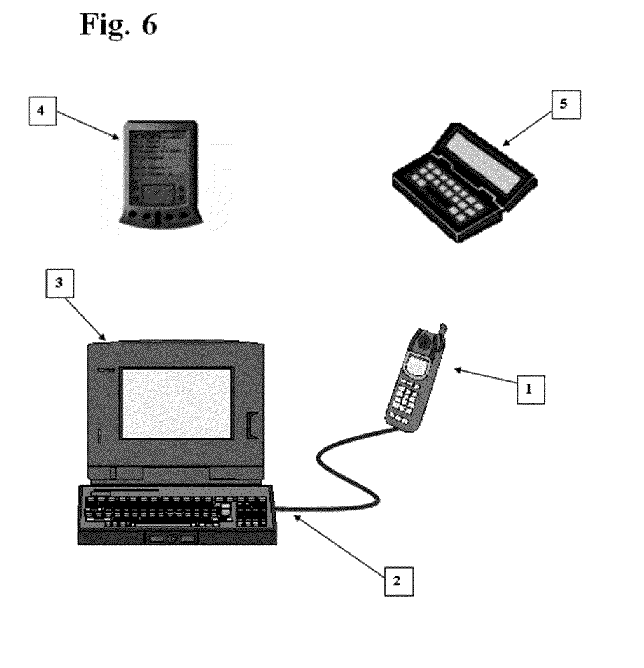

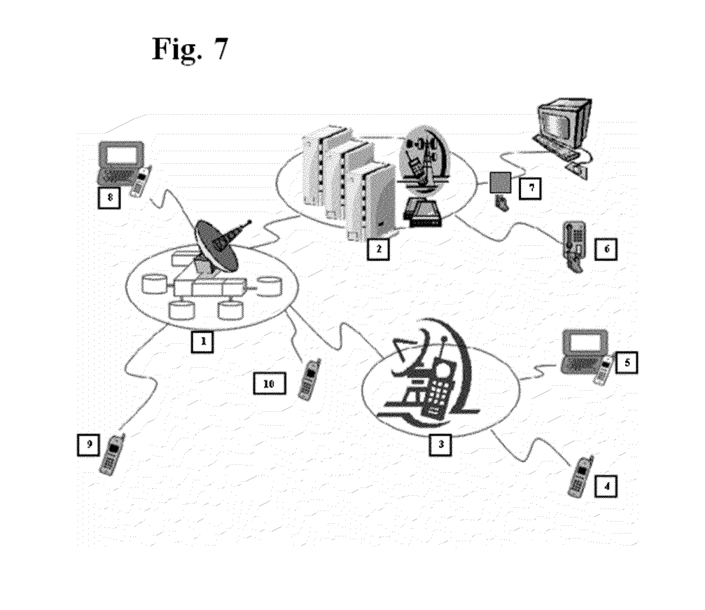

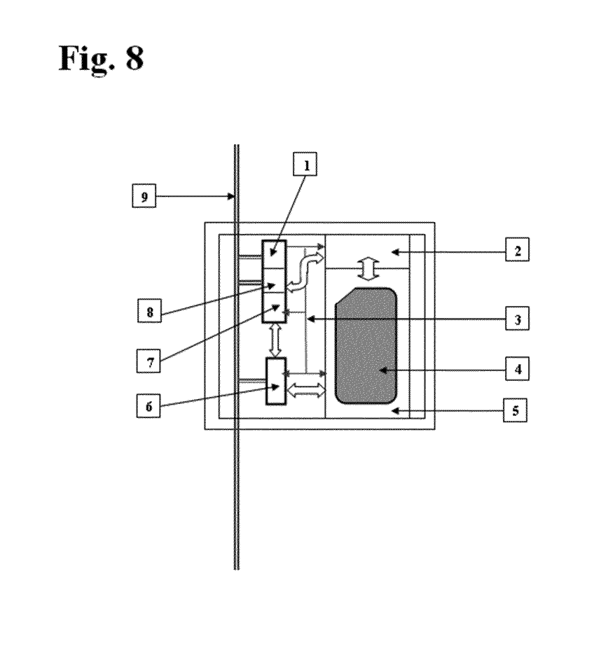

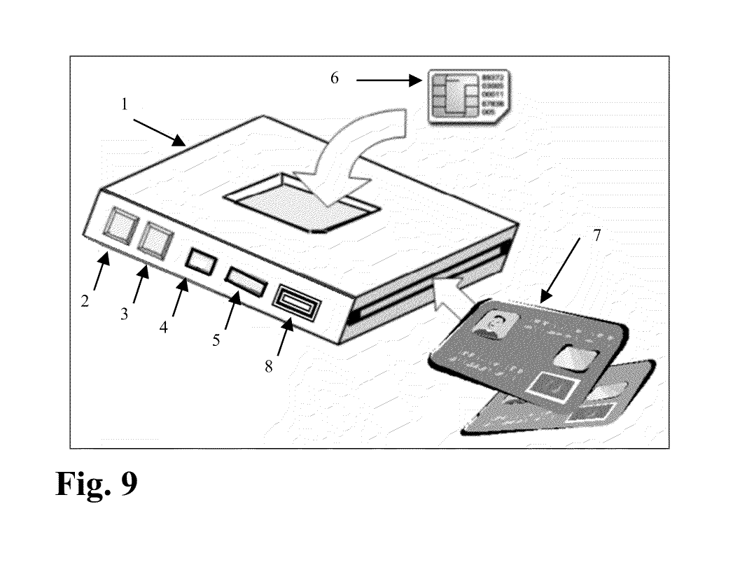

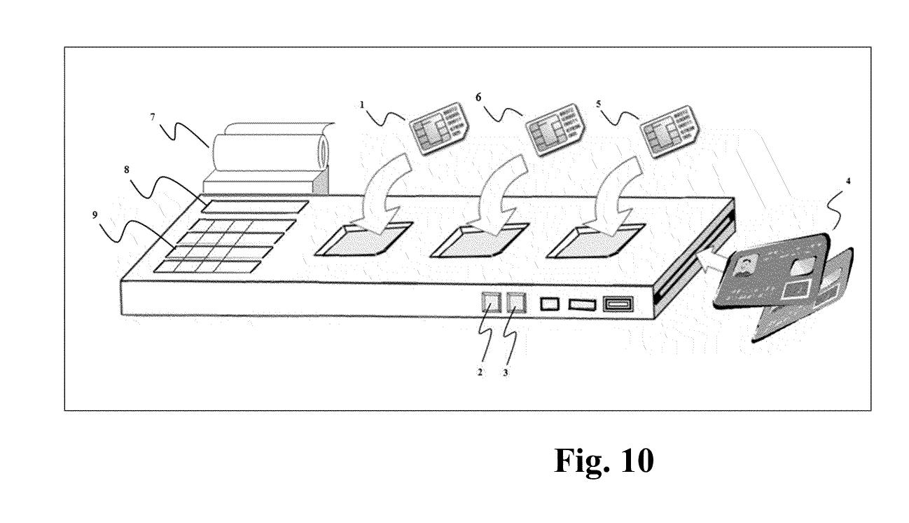

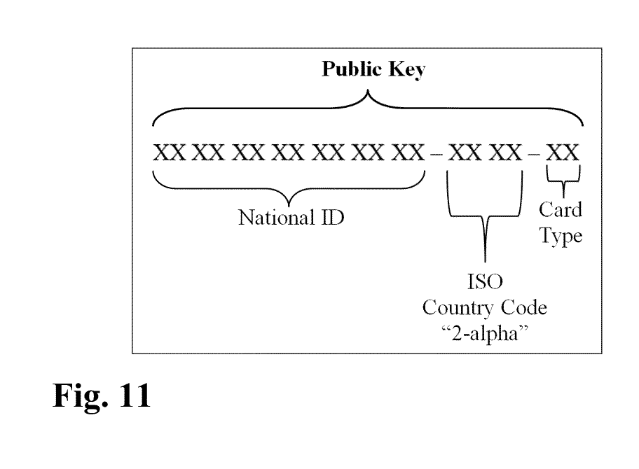

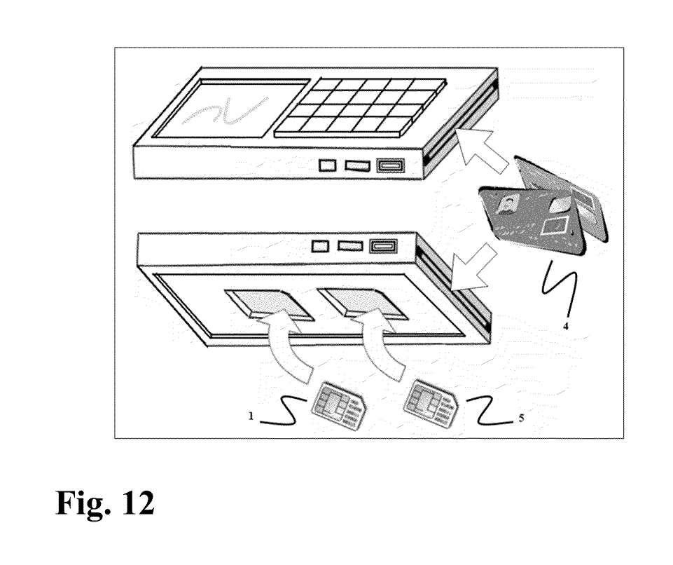

The presented invention introduces a new SIM/Smart Card Reader that is directly connected to the fixed line telephones using normal telephone line RJ type connections and without the need for special interfaces, connectors or adapters (FIGS. 1,2 and 3). Where, the newly invented SIM/Smart Card Reader includes the following basic and optional features that aim to enhance the effectiveness and efficiency of its use in the e-Services applications:
The tools and functions of the newly invented SIM/Smart Card Reader depend on BIOS (Basic Input Output System) and Micro Codes that can be updated and upgraded through the use of specialized PC (Personal Computer) programs. To perform such an upgrade, the SIM/Smart Card reader connects to the PC through USB interface port (9 figure item 8).
The electronic and logic circuitry of the SIM/Smart Card Reader include (as standard features) TCP/IP Processor (Transmission Control Protocol/Internet Protocol) and Flash ROM/RAM (Read Only Memory/Random Access Memory) that enable the fixed-phone/ground telephone network end-user to directly access the websites that provide e-Services via IVR and Internet applications.
The SIM/Smart Card Reader design includes (as an optional feature) the electronic circuitry, logic, microcode, cables, accessories and connections (FIGS. 8 and 9) that are necessary to connect and operate a 2.5″ Paper-roll Thermal or Ink Printer, for the end-user convenience to print the payment receipts immediately upon completing the e-services/e-Payment transaction, whether when using IVR applications (FIGS. 1 and 4), or using Internet applications (FIGS. 2, 3 and 5).
The SIM/Smart Card reader design include (as an optional feature) the electronic circuitry, logic, microcode, cables, accessories and connections (FIGS. 8 and 9) that are necessary to connect and operate a small LCD Display Screen, for the end-user convenience to review the data entered from the fixed-phone keypad, view and read the system issued messages and directions when using the IVR application to perform e-services/e-Payment transactions (FIGS. 1 and 4).
In addition, the presented invention suggests the production of a new generation of fixed telephone line sets with integrated SIM/Smart Card Reader (FIG. 4 and FIG. 5). In this new generation of fixed telephone sets, the LCD display screen, the USB cable interface and the 2.5″ paper-roll printer ports become standard features.

The e-Services (e-Government, e-Commerce) and e-Payment to be provided remotely through:
The same central systems of Telecom Operators managing Mobile Phone Networks that utilize the SIM Cards in authenticating/authorizing remote end-users (as already exist in various e-Services/e-Payment applications serving the Mobile Platform), or
The same central systems of Telecom Operators managing Fixed Phone Networks that use Intelligent Network applications, after performing the development and re-engineering activities to it that are necessary to make it accommodate the SIM based applications and tools required to manage the authentication/authorization processes that control the end-users access to the e-Services/e-Payment applications via landline networks.

The introduced invention collectively avails all the benefits and facilities of existing e-Payment tools and methods into one e-Payment Integrated Scheme that offers a seamless and scalable platform for the various levels of end-users to upgrade the tools they are using according to the level of their financial capabilities, where the e-Payment Integrated Scheme is characterized by the following:
The e-Payment Integrated Scheme links and integrates the following various e-Payment tools, schemes and methods that currently exist in real life:
Prepaid Cards
Electronic Prepaid Accounts
Credit/Normal Banking Cards
Each e-Services/e-Payment subscriber will be assigned an electronic bank account, where the end-user will:
Use of the same SIM Card in both Mobile Phones as well as Fixed-Line Phones SIM/Smart Cards Reader.
Use the same Smart Card in both A TM machines as well as Fixed-Line Phones SIM/Smart Cards Reader.
Access the e-Services/e-Payments via:
   Fixed-Phones (using the introduced SIM/Smart Cards Reader) in association with Internet applications. Or;
   Fixed-Phones (using the introduced SIM/Smart Cards Reader) in association with IVR applications without the need for any Personal Computers. In such a case, the end-user can perform the data entry either by using the keypad of the fixed-line elephone set, or will have the alternative option of using a Call Center Service (that will be availed as part of the presented e-Services/e-Payment scheme), where the Call Center agent will perform the data entry on behalf of the end-user. Or;
   Mobile Phones and Wireless Devices in association with IVR, Internet and W AP applications (as already exists in real life through various embodiment solutions that address the Mobile/Wireless Platform).
e-Services/e-Payment subscriber will be able to effect e-Payments through either one of the following alternatives:
Using Credit Cards or Prepaid Cards to refill (deposit) money into the electronic bank account mentioned above and e-Payments are effected as deductions (debits) from this electronic bank account. Or;
Using Credit Cards to directly remit e-Payments to a Provider (as is the case nowadays in IVR and Internet applications) with the extra value of enjoying the same level of authentication/authorization privileges, where electronic monetary remittances using Credit Cards will be conditioned by the prerequisite use of the SIM/Smart Card (provided that such a prerequisite conditioning is agreed upon and arranged with the Financial Institution that issued the Credit Card—such as Visa, Master Card, . . . etc).
The Prepaid Cards presented in this e-Payment Integrated Scheme are characterized by the following:
   Will be used in integration with the new SIM/Smart Cards to charge a central electronic bank account of the e-services subscriber in a fashion similar to what currently exists in the prepaid cards used with mobile phone subscribers.
   Will be issued in various and progressive money values, and will work as an e-Payment tool that aim to facilitate the e-Payment for the end-user categories who are not wealthy and consequently are unable to have credit cards or normal bank accounts.
   The above mentioned Prepaid Cards are suggested to be sold through various outlets (such as supermarkets, gas stations, post offices, . . . etc).
In addition, the presented invention suggests the development and production of a new “low-cost” mobile phone to be used only in remote electronic services to help in spreading the use of e-Services/ePayments within low income individuals. Where:
   The SIM card issued for the e-Services SIM subscriber will be dedicated only to e-Services/e-Payment, no vice communication service are allowed (except emergency numbers, such as ambulance, fire brigade, police, . . . etc)
   The new mobile keypad buttons and selection menus will be modified/re-engineered to suit the e-services applications and functions.
   The e-Services/e-Payment subscriber (with the New SIM inserted in this new mobile phone) will be allowed only to access the eServices via IVR and/or W AP applications.
   It is also suggested that other value-add services to be added to the newly suggested mobile phone, such as sending and receiving electronic messages/mails, performing e-banking transaction/service functions, . . . etc.

The invented e-Services Scheme is suggested to avail to the end-user the following various alternatives for Printing the e-Payment Receipts:
In all types of e-services applications (IVR, Internet and W AP), based on the end-user choice, the e-Payment Receipts can be printed centrally within the e-Services Provider and later delivered to the end-user address location via mail courier (might already exist in real life through some providers).
In IVR and Internet e-Services applications, the end-user can print the e-Payment Receipt immediately upon completing the e-Payment transaction using a 2.5″ Paper-roll Thermal (or Ink) Printer connectable to the SIM/Smart Card Reader (item 7 in FIGS. 1, 2, 3, 4 and 5).
In IVR and Internet e-Services applications, based on the end-user choice the data of the e-Payment Receipt can be recorded on the e-Service Smart Card (normal size cards) and later printed using an Automatic Teller Machine (ATM) closer to the end-user location, given that the ATM is prepared to provide this Printing Service (newly suggested printing embodiment).
In Internet e-Services applications, the end-user (in addition to the printing options mentioned above) can print the e-Payment Receipts using Personal Computer standard printer facilities (already exists in real life in all Internet applications).
In WAP e-services applications, the end-user can record the e-Payment Receipts data onto the e-services SIM Card storage (or the handheld device memory) and later transfers the e-Payment Receipts data to a Personal Computer via available link facilities (such as USB cable interface) and prints the recorded e-Payment Receipts using the Personal Computer standard printer facilities (might already exist in real life, where some providers send back undeniable electronic receipts to end-users).
Also, in WAP e-Services applications, the end-user can record the data of the e-Payment Receipts on the e-Services SIM Card storage (or the handheld device memory) and later prints the e-Payment Receipts data using an ATM machine closer to the end-user location by transferring the recorded e-Payment Receipts data to the ATM machine via Infrared linkage facilities, and then prints the e-Payment Receipts using the ATM machine printer, given that the ATM is equipped with Infrared linkage feature and is prepared to provide this printing service (newly suggested printing embodiment).

### BEST MODE FOR CARRYING OUT THE INVENTION

Remote access to e-Services (e-Government, e-Commerce) and e-Payment will be provided through the same central systems and applications installed within the inside plant infrastructure of Mobile Operators, that are based on the SIM technology, tools and functions after doing the necessary development and re-engineering activities to it to make it suitable for handling the e-Services remote access control, authentication, protection and functionalities (also for the objective of presented invention the central systems that will be re-engineered/developed to manage and control the e-Services/e-Payment applications, can be the inside plant Intelligent Network Systems of Fixed-Lines Telecom Operators that are normally used to manage the fixed phone subscribers' services).

Such central systems, development, re-engineering, administration and management shall be handled and sponsored by a locally capable Telecom Operator having the appropriate technical and financial capacities needed to support the remote e-Services on a country level and in coordination with a privileged organization that is trusted on the country level (in Egypt it is suggested that such coordination is done between Telecom Egypt and the Civil Status Organization of the Ministry of Interiors responsible for managing the national ID's of all citizens on the country level).

Both organizations (capable telecom operator and trusted organization) coordinate and liaise with local and international financial organizations (banks in addition to financial services institutions such as: Visa, Master Card, American Express . . . etc) to cater for the handling and management requirements of the central electronic banking accounts and the remote e-Payment transaction processing.

The above mentioned consortium (capable telecom operator, trusted organization, local and international financial organizations) will be the country e-Services/e-Payment custodian and will issue a SIM and a normal size Smart cards for each citizen requires to subscribe in the e-Services.

The e-Services will be provided through IVR (Interactive Voice Response) applications through fixed line telephones using the ground network communications as well as mobile phones using the cellular network communications.

The e-Services will be also provided via WAP (Wireless Application Protocol) and Internet applications.

The e-Services subscriber SIM or normal size Smart Cards will contain all the data required to handle a complete Public Key/Private Key Infrastructure scheme necessary to manage the e-Services subscriber profile and privileges plus managing and handling the subscriber e-Payment transactions through an electronic central banking account that is opened for each e-Services subscriber. In addition, the same SIM and/or normal size Smart Cards may carry data of other services (such as mobile phone and/or banking/Credit card), according to the subscriber needs and request.

The above mentioned e-Services consortium will coordinate the issuance of Prepaid Cards with different and progressive monetary values, these Prepaid Cards will be used to charge the respective prepaid card money value into the central electronic bank account of the e-Services subscriber and the remote e-Payments will be effected as deductions form the electronic bank account.

Also, e-Payments can be effected using normal banking/credit cards in association with the authentication/access controls and functionalities provided by the new SIM/Smart cards infrastructure and scheme.

The e-Services provider is to allocate specific telephone codes and telephone numbers for the various categories of the e-Services (e-Government and e-Commerce), for example 088-888 8888 for e-Government services and 5 099-999 9999 for e-Commerce services.

Accessing the e-Services via such numbers necessitate the physical use of the new SIM/Smart Cards inserted in the newly invented SIM/Smart Cards Reader with fixed line phones, or the Smart SIM card inserted inside the mobile phone or handheld devices as is already exists in real life.

### INDUSTRIAL APPLICABILITY

To exploit the invention there are eight components that have to be developed, re-engineered and/or manufactured.

The first component is the Telecom Operator central systems and applications, where the developments and re-engineering activities have to be coordinated between the whole e-Services consortium parties (telecom company, trusted organization, local and international financial institutions).

The development and re-engineering of the various components are already proven technologies that are used with different credit/banking cards applications used in association with ATM and/or POS machines, SIM based mobile phones and handheld device service applications, including the targeted e-Services/e-Payment applications.

The second component is the new SIM/Smart Cards design and manufacturing, where it is also a proven technology used in various mobile, banking, credit and prepaid cards that are based on the smart chip technologies.

In the proposed invention scheme, the exploitation necessitates that the parties members of the e-Services consortium (telecom company, trusted organization, local and international financial institutions) coordinate together the technical and legislative components needed to specify the tools, functionalities, protocols and procedures associating the electronic use of the new SIM/Smart cards with fixed line and mobile telephone sets and devices.

In the presented scheme each subscriber will be granted two versions of the e-Services/e-Payment cards, namely; an e-Services SIM (which is—as already exists in real life—a modified smart version of the SIM cards normally used in mobile phones) and an e-Services Smart Card (which is a modified smart version of the cards normally used in the Point Of Sale “POS” and Automatic Teller Machines “ATMs”). The e-Services subscriber will be able to interchangeably use both card versions, however the e-Services central systems will allow the subscriber to use one e-Services card at a time.

The third component is the newly invented SIM/Smart Cards Reader to be used in association with fixed line telephone devices, where the proposed technology is proved in various applications that involve add-on of devices to the normal fixed line telephones, such as caller-ID devices, long distance call controller devices, fixed line SMS devices, . . . etc.

The design and manufacturing of the newly invented SIM/Smart Cards Reader will require the design and manufacturing of electronic circuits; electromechanical components; VLSI circuits including microprocessors and microcode technology items (TOP/IP processor, flash ROM/RAM memory); circuitry; connectivity components and accessories required to connect the invented SIM/Smart Cards Reader to: Fixed-Line Network/Fixed-Line Handsets, Thermal/Ink Printers and LCD display screen.

The SIM/Smart Cards Reader functionality and logic designs will considerably depend on BIOS (Basic Input Output System) and Micro Codes so that the SIM/Smart Cards Reader can be updated and upgraded through the use of specialized PC (Personal Computer) programs. Accordingly, the SIM/Smart Card Reader will be equipped with USB port and interface to enable its linkage with Personal Computers.

The SIM/Smart Cards Reader will also require casing that has to satisfy the safety requirements of customer use and as well has to have a customer appreciated cosmetic appearance, such casing will require artwork design, mechanical dies and moulding machinery for mass production.

The fourth component is the Central Electronic Bank accounts and Prepaid Cards, where also such a technology is proven and used in the normal mobile phone voice services for subscribers using the prepaid cards scheme, and also are proven in some Mobile e-Services/e-Payment setups. In the introduced e-Services Scheme, the Telecom Operator will hold an electronic registry of the customer profile and the e-Services subscriber will use the Prepaid Cards to deposit money into his/her central account. The e-Payments will be deducted from the subscriber electronic account.

Also, the presented scheme introduces new service features that will be added to the use of Credit Cards (such as Visa, Masters, . . . etc), where the end-user will be able to directly remit e-Payments to a Provider (as is the case nowadays in IVR and Internet applications) with the extra value of enjoying the same level of authentication/authorization privileges, where electronic monetary remittances using Credit Cards will be conditioned by the prerequisite use of the SIM/Smart Card. Where, the prerequisite condition of using the e-Services SIM or Smart Cards to authenticate the end-user will be agreed upon and arranged with the Financial Institution that issued the Credit Card—such as Visa, Master Card, . . . etc.

The fifth component is the use of normal Fixed-Line Phones as access devices to the e-Services using both versions of the e-Service Cards (the SIM and the Smart Cards mentioned above) in association with the newly suggested SIM/Smart Cards Reader, where such technology is already proven in the Wireless (GSM and GPRS) “e-Services/e-Payment” services in association with Mobile and/or Handheld Devices.

The sixth component is the new generation of fixed line telephone sets with the invented SIM/Smart Card Reader integrated inside. In this new generation of telephone sets, the LCD display screen, the USB cable interface and the 2.5″ paper-roll printer ports become standard features.

The seventh component is the mobile phone dedicated only to the e-Services, where the new phone menus and keypad buttons are re-engineered and designed to optimally serve the e-Service transactions. The design and manufacturing of such a mobile telephone device will be similar to the normal mobile phones. However, the SIM card and the subscriber profile within the central systems of the e-Services provider will define the functionalities and privileges given to the subscriber and will limit it to the e-Service applications. The new mobile phone will allow the use of IVR, W AP and/or Internet applications to access and handle the e-Services and e-Payment transactions.

The eighth component is that availing and enabling the printing services of the e-Payment Receipts via Automatic Teller Machines (ATM) will require development and re-engineering activities to make the ATM prepared to perform the printing services.

The printing of the e-Payment Receipts recorded on the normal size Smart Cards will require re-engineering of the ATM programming.

The printing of the e-Payment Receipts recorded on the SIM Cards or memory of mobile or handheld devices, will require ATM hardware upgrade/re-engineering to enable the ATM of communicating with the mobile phones and handheld devices via Wireless (Infrared or Bluetooth) Linkage, In addition will also require re-engineering of the ATM programming.

### Point of Sale Embodiments

The invention presented in the PCT Patent Application titled “Scheme for Spreading and Facilitating Remote E-Services” introduced a POS (Point of Sale) system that provides the End-Users (Citizens and SMEs) with means of accessing electronic services remotely (while at home or office), which enable these End-Users of performing “Self-Initiated Electronic Payments” remotely (while the End-User is at home or office) in a secured way that is similar to, and complements the secured electronic payments that are performed onsite (while at banks, commercial malls, shops . . . etc) using the standard POS (Point Of Sale) terminals and ATM (Automatic Teller Machines).

This “Continuation In Part” (CIP) Application is aimed to realize the following:
Introduce new enhancements to the “e-Services New SIM Cards” presented in the section titled “Industrial Applicability” of the original PCT Patent Application.
Introduce new enhancements to the “Cards Reader” presented in the original PCT Patent Application.
Introduce new enhancements to the “New Generation of Fixed Telephone Sets” presented in the original PCT Patent Application.
Introduce new enhancements to the “New Mobile Phone Device” presented in the original PCT Patent Application.
Based on the above newly introduced enhancements, this CIP Application will also introduce a new POS (Point of Sale) Device that utilizes the values of the POS (Point of Sale) system that was introduced in the original PCT Patent Application [complete scheme of Public Key and Private Key Infrastructure, new SIM cards, which enabled end-user to perform e-Payment transactions via mobile phones or via fixed line phones in a secured and legally binding approach].
   This new POS (Point of Sale) Device realizes the requirements and the standards followed by the worldwide financial institutions (such as Visa & MasterCard) and at the same time is economically very competitive when compared to the currently available POS (Point of Sale) Devices, where currently the cheapest Point of Sale terminal costs around 1100 US Dollars & our newly introduced POS (Point of Sale) Device will be much more cheaper (around 100 US Dollars) without sacrificing any of the security standards and requirements that govern the handling of the data of the electronic payment transactions.

### Description of the Introduced Enhancements

New enhancements introduced to the “e-Services New SIM Cards”, where as it was mentioned in the PCT Applications, the “e-Services New SIM Cards” are smart cards similar in shape and size to the mobile SIM cards, are a modified version of the SIM cards currently used in mobile phones, integrated with the central systems that are normally used to manage the mobile phone subscriber services, after introducing to it the necessary development and re-engineering activities to make it suitable for the e-services applications (management and control of end-users' e-services subscriptions, authentication, transaction protection . . . etc). In this CIP Application, the following new enhancements are introduced to these above-mentioned “e-Services New SIM Cards”:
The “e-Services New SIM Cards” can be also smart cards similar in shape and size to the magnetic stripe cards such as those currently used in ATM machines, after introducing to it the necessary modifications, re-engineering & developments to make it suitable for the e-Services Systems introduced by the above-mentioned PCT Patent Application and this CIP Application. In which case, the Cards Reader will be enhanced as described below.
The “e-Services New SIM Cards” that is based on Smart Chip Technologies can be also an NFC Card (Near Field Communication) or an RFID Card (Radio Frequency Identification).
   In this case, the Cards Readers will be enhanced as mentioned below to cater for reading and interacting with NFC & RFID Cards.
In this CIP Application, the following new enhancements are introduced to the “Cards Reader”:
   The Electromechanical Design of the Card Reader is modified to introduce a second “Card Reader” model that caters for reading the “Smart Cards” that are “similar in shape and size to the mobile SIM cards” and that are “similar in shape and size to the magnetic stripe cards such as those currently used in ATM machines”. FIG. 9 schematic demonstrates such modification, where the electromagnetic/electromechanical design of the “Cards Reader” enables it of reading and interacting with both types of Cards (SIM-alike & ATM-alike cards).
This CIP Application introduces also a New POS (Point of Sale) Device, where in addition to the “Card Reader” models mentioned above, the “Card Reader” is also modified to introduce a third “Card Reader” model that is capable of acting as Point of Sale (POS) Machine that is characterized by being very cheap in cost when compared to the currently available solutions (will be around one tenth of cheaper that the cheapest traditional Point of Sale terminal) and at the same time will fulfill all the security requirements and standards requested and followed by the worldwide “Financial Institutions” (such as Visa & MasterCard) regarding the “Banking Sensitive Data” handled within the electronic payment transactions. The abidance of this “New POS Machine” to the security requirements and standards of the “Banking Sensitive Data” in addition to its cheapness of cost, make it suitable & economically feasible for the very small, small & medium retail shops (merchants) to utilize in accepting electronic payments from their walking-in Purchasers (Consumers). Where, in reference to FIG. 10:
The SIM Card (item #1) will be used to enable this new POS machine of communicating with the Cellular Communication Network.
The RJ Connections (items 2 & 3) will be used to enable this new POS machine of communicating with the Landline Communication Network.
The ATM-alike Card (item #4) or the SIM-alike Card (item #5) will be the “Digital Token” that carries the Public & Private Keys of the Purchaser (Consumer) and that he/she will use to pay the money due to the merchant electronically.
The SIM-alike Card (item #6) will be the “Digital Token” that carries the Public & Private Keys of the Retailer (Merchant) and that he/she will use to identify to the issuer and acquirer banks that this specific POS machine and all of the electronic payment transactions processed through it are related to this specific Retailer (Merchant).
Item #7 is the new POS Paper-Roll Printer that will print the Electronic Payment Transaction Receipts.
Item #8 is the new POS LCD (Liquid Crystal Display) Screen that will display the keyed in data and will also display the messages communicated from the “Central System” of the Bank.
Item #9 is the new POS keypad (numeric and function keys).
The “New POS Machine”, is characterized by the following:
The issuer and acquirer banks' authentication of the said new POS machine as being related to a specific Merchant will be accomplished via the “Digital Token” that carries the Public & Private Keys of the Retailer (Merchant), instead of authenticating it through the hardwired authentication ID that was used in the POS machines previous art.
The Public Key will be a combination the national ID number of the End-User (whether the Consumer or the Merchant) which will be 14 digits, 4 digits for the ISO Country Code (the “2-alpha” codes), and the last 2 digits will indicate the Card Type. FIG. 11 illustrates the Public Key format and structure.
For ISO Country Code (the “2-alpha” codes), please refer to: http://www.unc.edu/˜rowlett/units/codes/country.htm), in which case the value of the first two digits will indicate the first letter (by carrying its sequence in the alphabet list) and the second two digits will indicate the second letter (by carrying its sequence in the alphabet list), for example; Egypt's ISO Country Code (the “2-alpha code”), is EG, and the letter “E” is the 5^{th} letter in the alphabet and the letter “G” is the 7^{th} letter in the alphabet, then the “2-alpha” ISO Country Code of Egypt (which is EG), will be=57.
For the “Card Type”, the issuer and acquirer banks will have the chance to issue 100 different types of Cards to their customers (Merchants and Consumers).
In the prior art, the POS machines are expensive because they have to fulfill complex specifications regarding the security of reading and communicating the Banking Sensitive Data (the specifications that are stated by the EMV Co. “Europay, MasterCard, Visa—www.emvco.com”), the thing that makes the hardware, microcode & firmware of the POS machines of the prior art are very expensive. In the new POS machine & POS System introduced by this CIP Application, the security of the “Sensitive Bank Data” will be accomplished through another innovative approach, where the data that will be read by the new POS machine and communicated to the banks central systems, will be limited to the Public Key written on the “Digital Token” of the Consumer (which will serve as the Electronic Payment Card) and the Public Key written on the “Digital Token” of the Merchant (which will serve in Authenticating the Merchant's Identity as well as linking the “Electronic Payments” transacted via the “Consumer” Cards to the Authenticated Merchant's Bank Account), while all of the “Sensitive Bank Data” (whether the data of the Merchant or the Consumer) will be stored in “Digital Records” within “Database Tables” located within the Banks' “Central Systems”, where the “Sensitive Bank Data” of each specific Card of a specific “Merchant” or a specific “Consumer” will be pointed to in these tables using the Merchant's (or the Consumer's) “Public Key” as a unique identifier, as explained above, will determine the Country, the Citizen within this Country (whether he/she is a Merchant or a Consumer) and the Type of the Card issued to this Citizen. Thus, the only data transferred between the merchant and the central banking system is the merchant and consumer public keys, the merchant sign-on form, and the payment authorization form. To facilitate an authenticated transaction, the latter two items may be signed and by the merchant and consumer private keys, respectively.
The sequence of processing an “Electronic Payment” transaction will be as follows:
   The Merchant will use the “New POS Machine” to dial the “Bank Central System” that handles the “Electronic Payments”.
   The “Bank Central System” will establish a data link with the “New POS Machine” and will link it to a specific Merchant's Bank Account based on the Merchant's “Digital Token” inserted in the “New POS Machine”.
   The “Bank Central System”, within the Procedure that the Merchant has to follow to “Sign On” the “Bank Central System”, will issue a “Sign-On Electronic Form”, and prompts the Merchant to sign it off through the business-as-usual “Digital Signature” sign-off procedure, which will secure the Authentication of the Merchant's Identity and as well guarantee a legally binding commitment from the Merchant's side.
   The Consumer will allow the Merchant to make the “New POS Machine” read his/her “Digital Token” (issued to him/her to use it as an “Electronic Payment” Card of a specific type).
   The Merchant will enter the amount to be paid on the “New POS Machine” and the entered amount will be displayed on the LCD Screen of the “New POS Machine”.
   The “Bank Central System” will issue a “Payment Authorization Electronic Form”, and prompts the Consumer to sign it off through the business-as-usual “Digital Signature” sign-off procedure, which will secure the Authentication of the Consumer's Identity and as well guarantee a legally binding commitment from the Consumer's side (the “Bank Central System” will use the Consumer's Public Key to generate a “Hash-Total” for the “Payment Authorization Electronic Form” using the “Digital Signature” Algorithm and sends this “Hash Total” to the “New POS Machine”).
   The Consumer will enter his/her User ID & PIN Code on the Keypad of the “New POS Machine”, which will digitally sign-off the “Payment Authorization Electronic Form”, where the Consumer's “Digital Token” will generate a “New Hash Total” from the received “Hash Total” of the “Payment Authorization Electronic Form”, using the Consumer's “Private Key” stored on the Consumer's “Digital Token” and using the “Digital Signature” Algorithm and sends back the “New Hash Total” to the “Bank Central System”, which will secure the Authentication of the Consumer's Identity and as well guarantee a legally binding commitment from the Consumer's side.

Also, within all of the above “Card Reader” models, the “Card Reader” components (reading heads, electronic circuitry and electromagnetic designs) are modified to enable these “Card Reader” models of reading and interacting with NFC & RFID Cards.

This CIP Application also introduces enhancements to the “New Generation of Fixed Telephone Sets” presented in the original PCT Patent Application, where the “Card Reader” that is integrated inside the “Fixed Phone Set” is modified to become capable of reading and interacting with either one or all of the following types of Cards:
The “Smart Cards” that is similar in shape and size to the mobile SIM cards.
The “Smart Cards” that are similar in shape and size to the Bank Cards used in ATM machines.
The “Near Field Communication” (NFC) Cards.
The “Radio Frequency Identification” (RFID) Cards.

This CIP Application as well introduces enhancements to the “New Mobile Phone Device” presented in the original PCT Patent Application, where, with reference to FIG. 12:
The “New Mobile Phone Device” is modified to include the following features and capabilities:
   The SIM Card (item #1) will be sued to enable the “New Mobile Phone Device” of communicating with the Cellular Communication Network.
   The “New Mobile Phone Device” will be equipped with necessary components (Card Readers, Electronic Circuits, Electromagnetic and Electromechanical Components) that will make the “New Mobile Phone Device” capable of reading and interacting with either one or all of the following types of Cards:
   The “Smart Cards” that is similar in shape and size to the mobile SIM cards (item #5).
   The “Smart Cards” that is similar in shape and size to the Bank Cards used in ATM machines (item #4).
   The “Near Field Communication” (NFC) Cards.
   The “Radio Frequency Identification” (RFID) Cards.

1. A computerized point of sale system comprising:
a consumer slot for receiving and reading a digital consumer token, the digital consumer token comprising a consumer public key and a consumer private key;
a merchant slot for receiving and reading a digital merchant token, the digital merchant token comprising a merchant public key and a merchant private key; and
a communications apparatus for establishing a connection between a merchant and a central banking system, wherein the communications apparatus:
transmits the merchant public key to a central banking system, wherein the central banking system accesses a merchant account using the merchant public key,
receives an electronic sign-on form corresponding to the merchant account from the central banking system,
transmits a completed sign-on form to the central banking system, wherein the completed sign-on form comprises the electronic sign-on form digitally signed using the merchant private key upon entry of a merchant PIN code;
transmits the consumer public key and a currency total to the central banking system, wherein the central banking system accesses a consumer account using the consumer public key,
receives a payment authorization form corresponding to the merchant account, the consumer account, and the currency total from the central banking system,
transmits a completed payment authorization to the central banking system, wherein the completed payment authorization comprises the payment authorization form digitally signed using the consumer private key upon entry of a consumer PIN code.

2. The computerized point of sale system of claim 1, wherein the communications apparatus is configured for connecting to a mobile communications network.

3. The computerized point of sale system of claim 1, wherein the communications apparatus is configured for connecting to a landline communications network.

4. The computerized point of sale system of claim 1, wherein the communications apparatus further comprises a slot for receiving a Subscriber Identity Module (SIM) card.

5. The computerized point of sale system of claim 1, wherein the consumer slot is configured for receiving the digital consumer token in the form of at least one of a Subscriber Identity Module (SIM) card, a magnetic stripe card, a Near Field Communication (NFC) card, and a Radio Frequency Identification (RFID) card.

6. The computerized point of sale system of claim 1, wherein the merchant slot is configured for receiving the digital merchant token in the form of at least one of a Subscriber Identity Module (SIM) card, a magnetic stripe card, a Near Field Communication (NFC) card, and a Radio Frequency Identification (RFID) card.

7. The computerized point of sale system of claim 1, further comprising a Liquid Crystal Display (LCD) screen.

8. The computerized point of sale system of claim 1, further comprising a numeric keypad.

9. The computerized point of sale system of claim 1, further comprising a paper roll holder and a printer.

10. A computer-implemented method for completing buyer authentication at a point of sale, the method comprising:
establishing, at a computerized point of sale system, a connection to a central banking system;
transmitting, from the computerized point of sale system, a merchant public key to a central banking system, wherein the central banking system accesses a merchant account using the merchant public key;
receiving, at the computerized point of sale system, an electronic sign-on form corresponding to the merchant account from the central banking system;
transmitting, from the computerized point of sale system, a completed sign-on form to the central banking system, wherein the completed sign-on form comprises the electronic sign-on form digitally signed using the merchant private key upon entry of a merchant PIN code;
transmitting, from the computerized point of sale system, the consumer public key and a currency total to the central banking system, wherein the central banking system accesses a consumer account using the consumer public key;
receiving, at the computerized point of sale system, a payment authorization corresponding to the merchant account, the consumer account, and the currency total form from the central banking system;
transmitting, from the computerized point of sale system, a completed payment authorization to the central banking system, wherein the completed payment authorization comprises the payment authorization form digitally signed using the consumer private key upon entry of a consumer PIN code.

11. The computer-implemented method of claim 10, wherein the consumer public key and the consumer private key are stored on a digital consumer token.

12. The computer-implemented method of claim 11, wherein the digital consumer token is at least one of a Subscriber Identity Module (SIM) card, a magnetic stripe card, a Near Field Communication (NFC) card, and a Radio Frequency Identification (RFID) card.

13. The computer-implemented method of claim 10, wherein the consumer public key comprises at least one of a national ID, a country code, and a card type code.

14. The computer-implemented method of claim 10, wherein the merchant public key and the merchant private key are stored on a digital merchant token.

15. The computer-implemented method of claim 14, wherein the digital merchant token is at least one of a Subscriber Identity Module (SIM) card, a magnetic stripe card, a Near Field Communication (NFC) card, and a Radio Frequency Identification (RFID) card.

16. The computer-implemented method of claim 10, wherein the merchant public key comprises at least one of a national ID, a country code, and a card type code.

17. The computer implemented method of claim 10, wherein the connection is established using at least one of a Global System for Mobile Communications (GSM) protocol and a Code Division Multiple Access (CDMA) protocol.

18. The computer implemented method of claim 10, wherein the connection is established using a Plain Old Telephone Service (POTS) protocol.

19. The computer implemented method of claim 10, further comprising: receiving, at the computerized point of sale system, a transaction confirmation from the central banking system.

20. The computer implemented method of claim 10, further comprising:
generating, using the computerized point of sale system, a transaction receipt.
